(19) United States
(12) Patent Application Publication
(10) Pub. No.: US 2024/0185195 A1
(43) Pub. Date: Jun. 6, 2024

(54) METHOD FOR REAL-TIME TRANSFER OF FUNDS BETWEEN CUSTOMER AND SELLER INCLUDING GENERATING ACCOUNTING ENTRIES

(71) Applicant: William Herbert Loewen, Winnipeg (CA)

(72) Inventor: William Herbert Loewen, Winnipeg (CA)

(21) Appl. No.: 18/442,744

(22) Filed: Feb. 15, 2024

Related U.S. Application Data
(63) Continuation of application No. PCT/CA2023/050015, filed on Jan. 9, 2023.
(60) Provisional application No. 63/297,301, filed on Jan. 7, 2022.
(60) Provisional application No. 63/320,769, filed on Mar. 17, 2022.

(51) Int. Cl. G06Q 20/10; G06Q 40/12

(52) U.S. Cl. CPC G06Q 20/10; G06Q 40/12

(57) ABSTRACT

A method for use by a trusted intermediary to electronically transfer funds associated with a transaction between first and second parties, such as a customer and a seller, both of whom have accounts with financial institutions with respective established relationships with the trusted intermediary such that funds which are transferred can clear in real-time, that is virtually immediately, comprises steps of (i) electronically receiving, from a financial institution associated with a customer, the funds associated with the transaction, and holding the funds in a trust account; (ii) releasing control of the funds held in the trust account subject to confirmation that conditions of the transaction have been fulfilled; (iii) electronically transferring the funds released to a selected account at one of the financial institutions; and (iv) generating respective journal entries for the customer and the seller for posting the transaction to respective ledgers associated with the customer and the seller.

This is a continuation application of PCT/CA2023/050015 filed Jan. 9, 2023, which claims the benefit of U.S. Provisional Application Ser. No. 63/297,301 filed Jan. 7, 2022 and U.S. Provisional Application Ser. No. 63/320,769 filed Mar. 17, 2022.

### FIELD OF THE INVENTION

The present invention relates to a method for electronically transferring funds associated with one or more transactions between a customer and one or more sellers, virtually in real-time, and including a step of depositing the funds into a financial account of the seller, which method includes a step of generating accounting or bookkeeping entries for respective ledgers of the involved parties.

### BACKGROUND

When performing a transfer of monetary funds in association with a transaction between two parties, typically a customer or buyer and a seller, whether by cash, cheque or electronic means, there is often a delay between a transaction date, that is a date on which the transaction is contractually legally executed because all conditions of the transaction are fulfilled, and a posting or clearing date at financial institutions handling the funds involved in the transfer. The posting or clearing date defines a date on which the transfer of funds associated with the transaction between the customer and the seller is completed, meaning the funds are in the seller's control. Furthermore, this delay necessitates meticulous analyses at an end of a cut-off period, especially for the seller, to ensure the expected funds, associated with the transaction, match actual funds received.

Accounting often involves complementary transactions to be recorded in the accounts of the counter parties of a particular set of transactions. For example, when company A sells a product to company B on credit, company A would debit its accounts receivable for the amount due and credits sales or some other account for the credit side of the transaction. Company B would record a credit to accounts payable and a debit to expense when it learns of the transaction. Once company B learns that the goods have arrived it will then issue a payment to company A, and record the transaction by debiting accounts payable and crediting its bank account. In most instances, there will be gaps of one day to many days between the date of shipment by the seller and the date of receipt of payment for the goods or services provided. This involves use of working capital, often bank loans and sometimes collection costs.

Various iterations of this type of situation occur over and over by buyers and sellers and can make up 50 percent and more of the accounting entries of the two companies. Timing differences, errors, and other situations make it necessary to reconcile the affected accounts to make sure all the transactions have been recorded or will be recorded correctly by both companies. This work is a large part of the work of accounts payable and accounts receivable departments of most companies.

### SUMMARY OF THE INVENTION

It is an object of the invention to make it possible to automate the entire above-described process. The invention also replaces what we know as a clearing system such as the Canadian Payment System for these transactions.

According to an aspect of the invention there is provided:
A buyer who is willing to purchase goods that have been presented by a seller
A bank account from which a buyer can provide the funds required to pay for the goods selected.
A trust account into which the buyer can store the funds until it has agreed to the terms of sale required by the seller and any other regulative body requiring input related to the sale.
Databases of buyers, sellers and transaction details
A capability of a seller to provide a means of transferring the funds held in trust to the seller's. Bank account once all requirements have been met.

According to another aspect of the invention there is provided a method for use by a trusted intermediary to electronically transfer funds associated with a transaction between a first party and a second party, wherein the first and second parties have accounts with financial institutions each having an established relationship with the trusted intermediary such that funds transferred between a respective one of the financial instructions and the trusted intermediary are cleared in real-time, the method comprising:
(i) electronically receiving, from a first one of the financial institutions associated with the first party, the funds associated with the transaction, and holding said funds in a trust account;
(ii) releasing, to the second party, control of the funds held in the trust account subject to confirmation that conditions of the transaction have been fulfilled;
(iii) electronically transferring the funds released to the second party to a selected account at a second one of the financial institutions associated with the second party; and
(iv) generating respective journal entries for the first party and the second party for posting the transaction to respective ledgers associated with the first party and the second party.

According to another aspect of the invention there is provided a method for use by a trusted intermediary to electronically transfer funds associated with a transaction between a first party and a second party, wherein the first party and the second party have accounts with financial institutions each having an established relationship with the trusted intermediary such that funds transferred between a respective one of the financial instructions and the trusted intermediary are cleared in real-time, the method comprising:
(i) electronically receiving, from a financial institution associated with the first party, the funds associated with the transaction, and holding the funds in a trust account;
(ii) releasing control of the funds held in the trust account to a selected one of the first party and the second party based on input requested from at least one of the first party and the second party that conditions of the transaction have been fulfilled, wherein the second party is selected if the input determines all of the conditions have been fulfilled and the first party is selected otherwise;
(iii) electronically transferring the funds released to the selected one of the first party and the second party to a selected account at a corresponding one of the financial institutions associated with the selected one of the first party and the second party; and
(iv) generating respective journal entries for the first party and the second party for posting the transaction to respective ledgers associated with the first party and the second party.

Since money is moved from the first party to the second party, via the trusted intermediary, virtually in real-time, meaning that the ‘transaction date’ and the ‘posting date’ or date when the funds clear are the same, the trusted intermediary is in a position to generate representative journal entries for both the first party and second party's respective bookkeeping purposes. Thus, the transaction, including recordal of same in a ledger, can be fully automated with no human intervention other than approval of the transaction if the circumstances require human approval.

In one arrangement, generating respective journal entries comprises generating distinct journal entries for two or more of steps (i) to (iii).

Preferably, the distinct journal entries are generated at each of steps (i) to (iii).

In one arrangement, the method further includes transmitting the respective journal entries to the first party and to the second party for subsequent recordation in the respective ledgers.

In another arrangement, the method further includes storing the respective journal entries in a database of the trusted intermediary.

In one such arrangement, the respective journal entries are stored in the database of the trusted intermediary in the respective ledgers associated with the first party and the second party.

Preferably, the method further includes:
generating a unique identifier associated with a transfer of the funds, which is associated with the transaction; and
associating the unique identifier with each of steps (i) to (iii).

Preferably, the method further includes:
before receiving the funds associated with the transaction from the first financial institution of the first party, receiving instructions to initiate a transfer of the funds to the second party; and
forming the trust account, which is distinct, for use in the transfer, wherein the trust account is initially configured to be payable to the first party.

Preferably, in one such arrangement, releasing control of the funds held in the trust account comprises reconfiguring the distinct trust account to be payable to the second party.

Preferably, the method further includes, before releasing control of the funds in the trust account, requesting the confirmation that conditions of the transaction have been fulfilled, which comprises:
requesting, from the second party, confirmation that obligations associated with the second party have been fulfilled; and
requesting, from the first party, confirmation that the obligations associated with the first party have been fulfilled.

In one arrangement, transferring the funds released to the seller is performed at a scheduled future time on a date of the transaction.

In one arrangement, when the second party comprises a plurality of different second parties respectively engaged in a transaction for a prescribed amount of funds with the first party and on a common transaction date, electronically receiving the funds associated with the transaction from the first financial institution of the first party comprises electronically receiving funds in an amount of a sum of the transactions between the first party and the different second parties.

### BRIEF DESCRIPTION OF THE DRAWINGS

The invention will now be described in conjunction with the accompanying drawings in which:

FIG. 1 is a schematic diagram of agents or entities involved in the method of the present invention;

FIG. 2 is a flowchart of an arrangement of the method of the present invention;

FIG. 3 is a schematic diagram of a trusted intermediary's system;

FIG. 4 is a schematic diagram showing computing devices of a customer and a seller; and

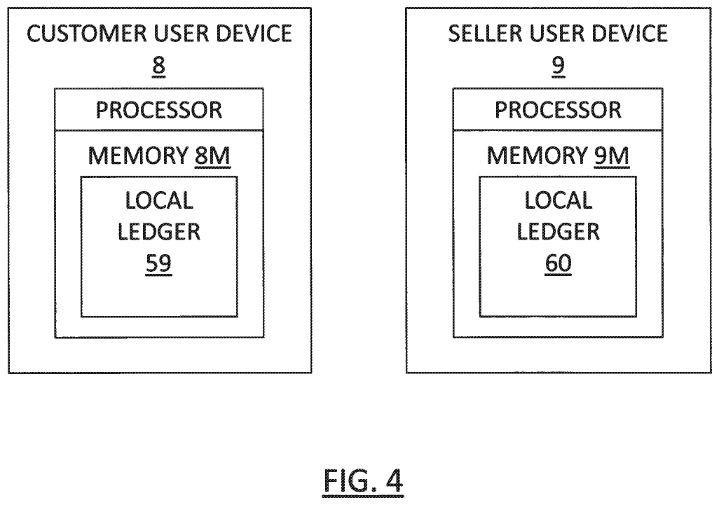

FIG. 5 is a flowchart of a method performed by the trusted intermediary; and

FIG. 6 is a flowchart of another arrangement of the method of the present invention.

In the drawings like characters of reference indicate corresponding parts in the different figures.

### DETAILED DESCRIPTION

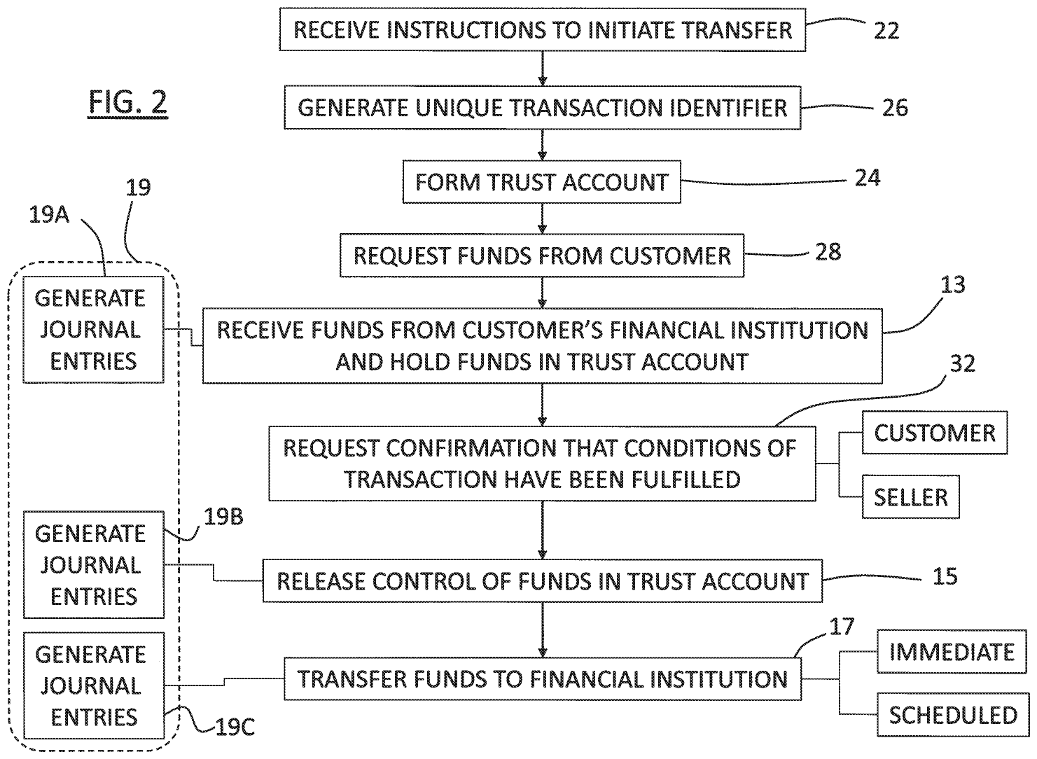

Referring to the accompanying figures, there is shown a method (FIG. 2) for use by a trusted intermediary 1 to electronically transfer funds associated with a transaction between first and second parties, such as a customer 2 and a seller 3, where the customer 2 and the seller 3 have accounts 2A, 3A with financial institutions 5, 6 each having an established relationship with the trusted intermediary 1 such that funds transferred between a respective one of the financial instructions and the trusted intermediary are cleared in real-time. For example, to provide the established relationship between the trusted intermediary and the financial institutions, the trusted intermediary has existing financial accounts with the financial institutions 5, 6 where the customer and seller have their accounts. The customer's and seller's financial institutions 5, 6 may be the same, in the event that both the customer and seller have respective financial accounts 2A, 3A therewith and accordingly have respective financial account data 2B, 3B stored thereat, or different institutions. The financial account data 2B, 3B typically describes the financial account 2A, 3A and thus can be considered a component or metadata thereof. Preferably, the financial accounts 2A, 3A of both parties are bank accounts at banks, which have respective established relationships with such regulatory bodies verification processes on origins of funds in accounts held thereat, so that the funds are considered clean.

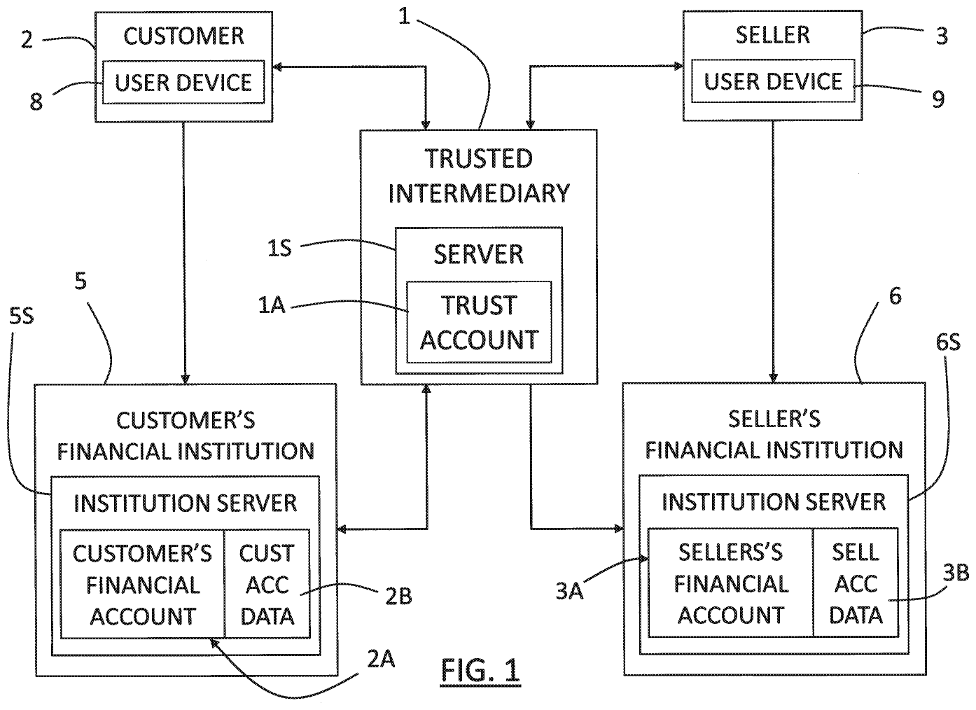

With reference to FIG. 1, the method is performed in the context of an electronic or digital, financial transacting or banking environment between the customer 2 and seller 3, who are typically remote to one another, and who use respective computing devices 8 and 9, such as smartphones, to communicate and interface with a server 1S of the trusted intermediary. Each of the financial institutions 5, 6 of the customer and the seller, which may be the same or different institutions, have respective servers 5S, 6S storing financial information or data of a corresponding one of the customer and the seller, with which the respective user devices of the customer and the seller, and the server of the trusted intermediary, are operatively communicated, for example by a data transmission network such as the Internet or cellular communication network.

Each of the computing devices 8, 9 and the servers 1S, 5S and 6S comprises a processor and a non-transitory memory or storage medium operatively coupled thereto to execute instructions stored thereon. The computing devices 8, 9 are configured to receive input from a user, for example by a touch-sensitive screen (not shown), and include a display (not shown) configured to display information to the user, for example a screen or monitor.

Thus, there is provided a computerized or digital or electronic banking or financial transacting system comprising a customer's computing device 8, a seller's computing device 9, servers of financial institutions 5S, 6S storing financial account data of the customer and seller 2B and 3B, and a server 1S of the trusted intermediary storing a trust account 1A and corresponding data to facilitate the transaction.

The trusted intermediary 1 comprises a system, including the server 1S, which is configured to execute the method as shown in FIG. 2 to perform or provide the electronic transfer of funds associated with the transaction between the customer and the seller. The method generally comprises the steps of:
(i) as indicated at 13, electronically receiving, from a first one of the financial institutions associated with the customer, that is the customer's financial institution indicated at 5, the funds associated with the transaction, and holding these funds in the trust account 1A;
(ii) as indicated at 15, releasing, to the seller 3, control of the funds held in the trust account 1A subject to confirmation that conditions of the transaction have been fulfilled;
(iii) as indicated at 17, electronically transferring the funds released to the seller to a selected account, for example 3A, at the second financial institution associated with the seller, that is the seller's financial institution indicated at 6; and
(iv) generating respective journal entries for the customer 2 and the seller 3 for posting the transaction to respective ledgers 2L and 3L associated with the customer and the seller, as indicated at 19.

Prior to execution of the method, the customer 2 “meets” or contacts the seller 3 through a marketplace, typically virtual or online, which is outside the system of the trusted intermediary 1. Once a transaction to procure goods or services from the seller is formed or established, which usually takes place outside the trusted intermediary's system 1, usually via a platform belonging to and operated by the seller, the seller's platform is configured to redirect and connect the customer 2 with the trusted intermediary's system 1 by which to pay the seller 3. Payment forms one of the conditions of the transaction, which is fulfilled by the customer 2.

Thus, with the transaction formed, the method includes an initial step of receiving instructions to initiate a transfer of the funds to the seller 3 in association with the transaction, as indicated at 22, which occurs prior to the funds being received by the trusted intermediary's system 1 at step 13. As previously stated, the instructions are generally provided by the seller 3 via the seller's platform, with which the customer 2 is temporarily operatively connected. This step therefore includes operatively connecting the computing device 8 of the customer with the trusted intermediary's system 1.

Additionally, before receiving the funds associated with the transaction from the customer's financial institution at step 13, the method includes a step of forming the trust account 1A, which is distinct, for use in the transfer associated with the transaction, as indicated at 24. The trust account 1A is initially configured to be payable to the customer 2 in the event the transaction is not completed because conditions or terms thereof are not met.

It will be appreciated that in the interest of privacy and security, the trusted intermediary's system 1 does not store nor have access at any time to financial account data of the customer. However, when the trust account is “configured to be payable to the customer,” this means that the system 1 either (i) is configured to return the funds to their source (account), in which case the trusted intermediary's system is configured to temporarily store the financial account data of the customer to enable the potential return of the funds to the customer (and after a refund to the customer, or if the method progresses to the subsequent step, then the customer's account data is erased by the trusted intermediary's system); or (ii) gives the customer the control to decide where to transfer the funds upon failure to meet conditions/terms of the transaction. This relates to ‘title’ of the funds. The control may be provided in the form of access to a unique link for depositing the funds in the trust account. Therefore, in the event the transaction is not completed, the trusted intermediary's system 1 may transmit or communicate a link to the customer's computing device 8 with instructions for depositing the funds to a selected account of the customer's choosing, which may be specified manually by an input field configured to accept text including numerical digits. Alternatively, the trusted intermediary's system may be configured to automatically transfer the funds from the trust account to a digital wallet associated with the customer and maintained in the trusted intermediary's system, that is a trust account in the trusted intermediary's system but operated by the customer to store funds belonging to the customer for processing in transactions to be performed by the trusted intermediary. Funds from the digital wallet may also be transferred to the customer's financial account at the financial institution which is external to the trusted intermediary's system.

Before receiving the funds associated with the transaction at step 13, the method also further includes a step of generating a unique identifier, basically a serial number, associated with the transfer, which is indicated at 26. The unique identifier is associated with operations associated with the transfer, that is each of the constituent steps 13, 15 and 17. This may be achieved by linking or including the unique identifier in a data packet representative of each step of the transfer.

After the trust account 1A has been formed or setup at 24, and before the funds are received at 13, the method includes a step of requesting funds from the customer, as indicated at 28. This may be achieved by an actionable prompt presented to the customer 2 on their computing device 8 operatively communicated and connected to the trusted intermediary's system 1.

After the funds have been received and while they are being held in the trust account 1A at step 13, the method includes a step of requesting confirmation that conditions of the transaction have been fulfilled, as indicated at 32, which includes requesting, from the seller 3, confirmation that obligations associated with the seller have been fulfilled, such as allocating product to be acquired in the transaction and shipping the same, and requesting, from the customer 2, confirmation that the obligations associated with the customer have been fulfilled, such as providing the funds identified in the transaction, more specifically in a value thereof, and satisfying a minimum age requirement. In other words, each of the parties involved in the transaction, namely the customer and the seller, are respectively requested to provide confirmation as to whether the transaction's conditions have been fulfilled which will determine whether the funds can be released to the seller. Thus, this acts as a two-step verification that the transaction can be completed on the basis of the conditions being fulfilled. Furthermore, this verification is a self-verification as each party is requested to confirm conditions to be fulfilled by that party.

In addition or alternatively to requesting confirmation from the customer 2 that the condition of sufficient payment for the transaction has been provided, the trusted intermediary 1 may compare the received funds in the trust account 1A against the value of the transaction, which is provided to the trusted intermediary's server 1S from the seller's platform.

In requesting confirmation from either the customer or the seller, the trusted intermediary's system 1, and more specifically server 1S, may provide a checklist showing all or selected ones of the conditions relevant to the party from whom confirmation is being requested. The checklist may comprise a list of optionally selectable fields each adjacent text describing one or more of the transaction conditions, all of which must be selected by input from a corresponding one of the customer and the seller to the corresponding computing device 8 or 9 to indicate to the trusted intermediary's system that the conditions have been satisfied.

Typically, besides receipt of payment which is associated with the value of the transaction, the conditions of the transaction are predetermined, being provided by the seller, and are stored in the trusted intermediary's system 1 on a database 1D thereof, which may be distinct or the same as the server 1S. For example, transaction conditions are stored as part of a seller's profile 3P which is formed by the seller by providing input to the trusted intermediary's database 1D where it is also stored.

After receiving confirmation that conditions of the transaction have been fulfilled, meaning that all obligations have been met by both the customer and the seller, the method includes the step 15 of releasing control of the funds held in the trust account. This allows the seller 3 to select or specify a destination account outside the trusted intermediary to which to transfer the held funds. In the illustrated arrangements, this step 15 comprises reconfiguring the distinct trust account 1A to be payable to the seller. As previously described, control of the funds held in the trust account 1A may be provided by transmitting or communicating to the seller's computing device 9 a unique link for depositing the funds in the trust account 1A. This link includes financial account data 1B describing or identifying the trust account 1A, such as branch, institution and transit numbers, and a request for input from the seller 3 as to a selected account at the seller's financial institution 6 where the held funds will be transferred.

Once the trusted intermediary's system has received the seller's input as to the selected account for the released funds, the released funds are ready to be transferred thereto. The transfer at step 17 may be performed immediately, meaning upon receipt of the necessary routing information for the funds, or may be performed at a scheduled future time on the date of the transaction.

Payment preferences such as timing of funds transfer may be stored on the trusted intermediary's database 1D as part of the seller's profile 3P, where the seller activates or selects an option for batch transmission of funds whereby all transfers on a common date are performed as a batch, meaning altogether, at an end of the day of the date, for example a sufficiently late time at which the funds can be transferred to the seller's financial institution while still being considered to have been received on the date of the transaction.

In batch transmission, funds from a plurality of transactions on behalf of a plurality of sellers may be concurrently transferred to a common financial institution associated with a subset of the sellers. In such a scenario, the trusted intermediary's system 1S is configured to group funds, scheduled to be transferred at the end of the day, by sellers' financial institution and to append, for each financial institution, instructions for distribution of grouped funds to different financial accounts associated with the subset of sellers. This may also be referred to as transmission distribution.

The trusted intermediary's database 1D also stores a profile for the customer formed thereby, indicated at 2P, which includes information such as name and shipping address. As will be appreciated shortly, the profiles of each of the customer and the seller may also include information necessary to form and maintain a ledger on behalf of a respective one of the customer and the seller, such as a listing of relevant accounts (for example, cash, accounts payable and accounts receivable) categorized as one of an asset, liability, equity, income and expense.

As part of the real-time transfer of funds, including requesting user confirmation as to fulfillment of transaction-related obligations or conditions, the method includes the step 19 of generating respective journal entries for the customer 2 and the seller 3 for posting the transaction to respective ledgers associated with the parties. More specifically, in the illustrated arrangement, distinct journal entries are generated by the system 1 for two or more of constituent steps of the transfer, that is steps 13, 15 and 17, and preferably at all of these steps, as indicated at 19A through 19C in FIG. 2. This is because funds are moved from one entity, namely the customer's financial institution 5, to another in the system represented by FIG. 1, namely the trusted intermediary 1, even before the transaction is considered finalized to allow the funds to complete the transfer to the seller 3 to move from the trusted intermediary 1 to the seller's financial institution 6.

However, since the method includes a step of user-confirmation as to fulfillment of transaction conditions, antecedent to which is movement of funds from the customer to the trusted intermediary, which is one of the conditions to the transaction (belonging to and to be fulfilled by the customer), then in the event the transaction is not finalized, respective journal entries may be generated only at 19A in association with step 13.

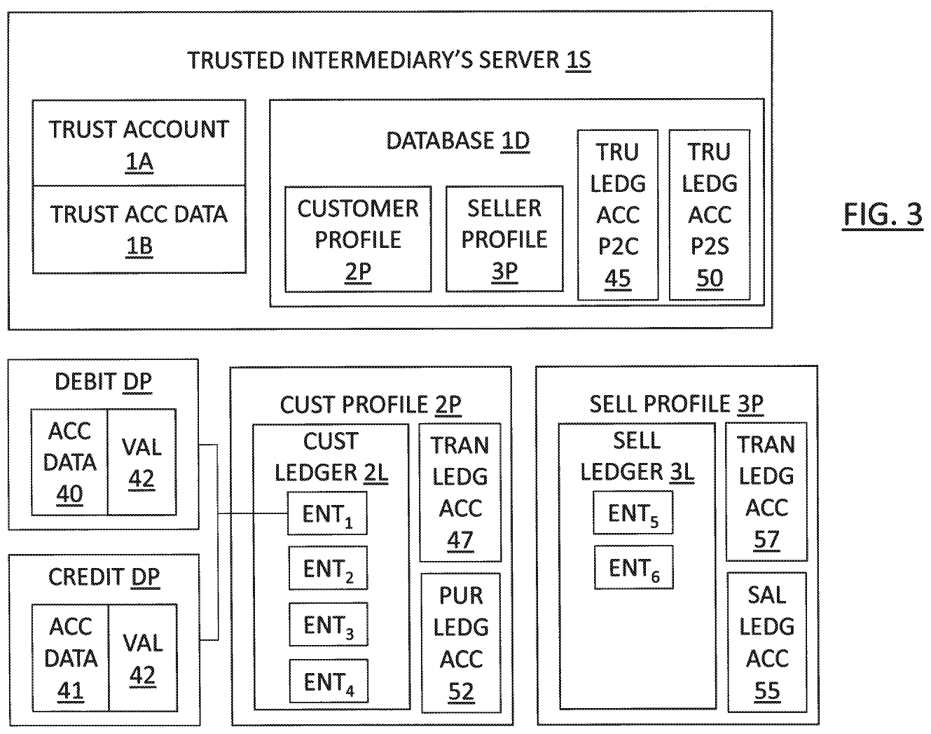

With reference to FIG. 3, in the illustrated arrangement the respective ledger of each of the transacting parties, in this case indicated as 2L for the customer and 3L for the seller, is stored on the trusted intermediary's database 1D in the profile associated with a corresponding one of the customer and the seller, either 2P for the customer or 3P for the seller.

Distinct journal entries such as 19A through 19C are generated automatically by the system 1 in response to each step in the transfer in which funds are moved or title thereto changes. Each journal entry, indicated for example at ENT₁ through ENT₆, is formed from a perspective of a transacting entity, that is the customer or the seller—not the trusted intermediary—and comprises a debit portion DP and a credit portion CP (this is illustrated with respect to one entry only, namely ENT₁, for clarity and convenience of illustration). Each of these entry portions DP, CP comprises data 40, 41 defining an account against which the debit or credit is to be applied, where account data of the debit portion DP is indicated at 40 and account data of the credit portion CP is indicated at 41, and a data in the form of a numerical value 42 defining a monetary amount of the debit or credit which is the same.

In accordance with step 13 in which the trusted intermediary 1 receives and holds the customer's funds in trust, pending finalization of the transaction comprising customer and seller confirmation of fulfillment of transaction conditions, the system server 1S automatically generates a first journal entry ENT₁ for posting to the customer's ledger 2L describing the step from the perspective of the customer. Specifically, the entry ENT₁, corresponding to the step in which funds are made available for the transaction, comprises a debit portion to a ledger account 45 stored on the trusted intermediary's database 1D and representative of the trusted intermediary's trust account 1A configured to be payable to the customer 2. The debit portion of the entry ENT₁ has a value defined by the funds received from the customer, which information or data is received by referring to a balance of the trust account 1A. A credit portion of entry ENT₁ is applied to a ledger account 47 representative of the customer's financial account 2A, which may be referred to as a transacting account of the customer, and having the same value as the aforementioned debit portion.

In the event that the transaction conditions are not fulfilled, in particular conditions applied by the customer 2 on the transaction, for example the provided funds differ from the earlier identified purchase price, then instead of releasing control of the funds to the seller at step 15, the control of the funds in the trust account 1A is released to the customer 2. This release step comprises requesting, from the customer 2, account information defining an account at the customer's financial institution 5, which may be the account 1A from which the funds were initially withdrawn, to which to transfer the funds out from the trust account 1A. Subsequently, the method includes a step of electronically transferring the funds released to the customer to the selected account, such as 1A, at the customer's financial institution 5. The distinct journal entry for the foregoing, represented by ENT₂, comprises a debit portion DP to the ledger account 47 representative of the customer's selected bank account for the value of the funds in the trust account 1A and a credit portion CP for the same value to the trust ledger account 45 payable to the customer. The data for the values of the debit and credit portions is retrieved by referring to the trust account data 1B indicating the balance of the trust account 1A.

In the event the transaction is completed, meaning all conditions thereof are satisfied or fulfilled, then distinct journal entries responsive to step 15 are generated for both the customer 2 and seller 3 as represented by 19B. For the customer, a pair of accounting entries are used to describe finalization of the transaction including completion of the transfer via the trusted intermediary 1. A first distinct one of the pair of customer's entries, indicated at ENT₃ in FIG. 3, comprises a debit portion to a ledger account 50 stored on the trusted intermediary's database 1D and representative of the trusted intermediary's trust account 1A when configured to be payable to the seller 3, and a value thereof corresponds to the value of the funds received from the customer and held in the trust account 1A at step 13. The credit portion of the entry ENT₃ is applied to the ledger account 45 representative of the trusted intermediary's trust account when configured to be payable to the customer 2. Even though the trust account 1A is the same, reconfiguration thereof for payout to a different entity in accounting terms constitutes a different ledger account hence the presence of ledger accounts 45 and 50 for the trusted intermediary 1. In addition to entry ENT₃, a second distinct journal entry of the aforementioned pair indicated at ENT₄ is generated for the customer 2 in accordance with step 15 to record the purchase, which comprises a debit portion to a purchases ledger account 52 stored on the customer's profile 2P of the value of the funds received from the customer and held in the trust account 1A, and a credit portion applied to the trust ledger account payable to the seller 50 of the same value. The data for the values of the debit and credit portions of entries ENT₃ and ENT₄ is obtained by referring to the trust account data 1B showing the balance of the trust account 1A.

Accounting entries describing the transaction with respect to the seller are generated the earliest in response to step 15. The distinct journal entry for the seller's respective ledger 3L, indicated at ENT₅, comprises a debit portion to the trusted intermediary ledger account payable to the seller 50 in the value of the funds received from the customer and held in trust in 1A, and a credit portion to a sales ledger account 55 stored in the seller's profile 3P of the same value, which records the sale as soon as the seller has control of (title to) the funds. The data for the values of the debit and credit portions of entry ENT₅ is obtained by referring to the trust account data 1B showing the balance of the trust account 1A.

Once the seller 3 has selected the desired destination account for the funds payable to the seller but held in the trust account 1A, for example account 3A at the seller's financial institution 6 that has the established relationship with the trusted intermediary 1, the funds are transferred out of the trust account 1A and thereto, and in response to the transfer at step 17, the system is configured to generate a distinct journal entry as represented by 19C, which is indicated at ENT₆ in FIG. 3. The distinct journal entry ENT₆ for the seller's ledger 3L comprises a debit portion to a transaction ledger account 57 stored in the seller's profile 3P of the value of the funds in the trust account 1A, and a credit portion of ENT₆ is applied to the trusted intermediary's ledger account payable to the seller 50 of the same value. The data for the values of the debit and credit portions of entry ENT₆ is obtained by referring to the trust account data 1B showing the balance of the trust account 1A.

In addition to storing the respective ledgers in separate profiles for each customer and seller registered with the trusted intermediary, simplified and consolidated versions of these transactional details are maintained in a separate database accessible by both customers and sellers to retrieve previously recorded transaction data. This database of historical transaction data is also available to the trusted intermediary for billing and statistical purposes.

The stored journal entries representative and descriptive of the transaction, entered and recorded or saved into the respective ledger 2L or 3L of a corresponding one of the customer and the seller, may be transmitted by the trusted intermediary server 1S to the corresponding entity. In other words, the method may include a step of transmitting, after generating the respective journal entries at step 19, these journal entries to the customer and to the seller for subsequent recordation in respective ledgers 59 or 60 stored locally on a non-transitory memory 8M, 9M of a respective computing device 8 or 9 associated with a corresponding one of the customer 2 and the seller 3. Preferably, the transmitted entries are of a standardized format configured for input into third-party accounting software for bookkeeping along with all other financial transactions performed by the customer and the seller.

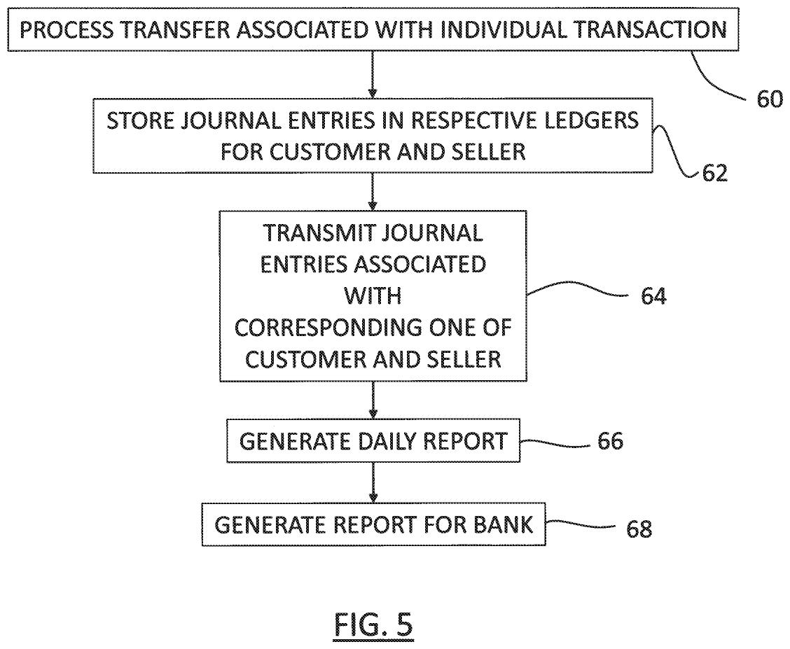

Furthermore, a record of the activity that has taken place with each transaction is maintained in a separate form where the customer Thus, an overall method performed by the trusted intermediary 1 includes the following general steps, shown in FIG. 5:
1. Process the transfer associated with an individual transaction to move funds from a customer to a seller, as indicated at 60 and shown in FIG. 2;
2. Store the generated journal entries from 60 in respective ledgers 2L, 3L for the customer and the seller, as indicated at 62;
3. Optionally transmit the generated journal entries to the respective user devices of the customer and seller, as indicated at 64;
4. Generate a daily report of all transfers processed, as indicated at 66, and preferably including, when applicable, a state of the customer's digital wallet; and
5. Optionally generate a report based on one or more daily reports for a bank or financial institution, such as that of the customer or the seller or a central bank, as indicated at 68.

The system may be configured to provide to the customer or seller the journal entries in a format suitable for storage in a corresponding system thereof. This conversion may take place in relation to step 62 or 64.

More specifically, the report at step 66 comprises lists of customer transactions and seller transactions.

More specifically, the report at step 68 may comprise a daily settlement report of a format which allows the bank or financial institution to assess and determine ability of the trusted intermediary. This is especially true when the bank or financial institution is a central bank.

Thus, since money is moved from the customer 2 to the seller 3, via the trusted intermediary 1, virtually in real-time, meaning that the ‘transaction date’ and the ‘posting date’ or date when the funds clear are the same, the trusted intermediary is in a position to generate representative journal entries for both the customer and seller's respective bookkeeping purposes. Thus, the transaction, including recordal of same in a ledger, can be fully automated with no human intervention other than approval of the transaction.

In other words, the computer-implemented method performed by the computerized system of the trusted intermediary 1 comprises the following steps:
(a) electronically receiving, from a financial institution associated with a customer, the funds associated with the transaction, and holding the funds in a trust account;
(b) releasing control of the funds held in the trust account to a selected one of the customer and the seller based on input requested from at least one of the customer and the seller that conditions of the transaction have been fulfilled, wherein the seller is selected if the input determines all of the conditions have been fulfilled and the customer is selected otherwise;
(c) electronically transferring the funds released to the selected one of the customer and the seller to a selected account at a corresponding one of the financial institutions associated with the selected one of the customer and the seller; and
(d) generating respective journal entries for the customer and the seller for posting the transaction to respective ledgers associated with the customer and the seller.

More specifically, in regard to step (b) above, the intention is to release control of the funds to the seller but this occurs only when the system determines that all of the conditions of the transaction have been fulfilled. Input as to fulfillment of the transactions is requested from at least the customer and preferably also the seller. Therefore, if the system determines that based on this input all conditions of the transaction are fulfilled, control of the funds is released to the seller. However, if the system determines that at least one of the conditions has not been fulfilled, or in other words is incomplete, control of the funds is released to the customer.

Thus, it is the party to whom the funds have been released who selects the receiving account for the funds in relation to step (c) above.

Moreover, it will be appreciated:
The unique transaction identifier is generated near the very beginning of the process and propagated to all the elements of the process. This is partly for security but mainly so that each customer's transactions can be identified separately from the transaction of other customers using the system at the same time.
Certain payments are subject to scrutiny by some authority or other. That can be before a customer has concluded it can proceed with the purchase, it can be before a seller can conclude a sale, or it can be conditional on both participating in a particular decision. The buyer and seller databases will signal the details of the condition that applies to the situation.
Funding a transaction could be done by withdrawing funds from a digital wallet. However the objective of this patent is to deal with funds that have come from a bank account. Doing so allows the system to handle payments without concern for money laundering. At the moment the only situation where that can be assured is if funds received come from a bank account or any other organization that is required to identify laundered money before it can be accepted.

As such, with the arrangement described hereinbefore, there is no need for a financial clearing system. The commencement of the payment process is at the customer's decision to purchase and provide the funds to purchase rather than at the clearing system thereby eliminating the clearing system.

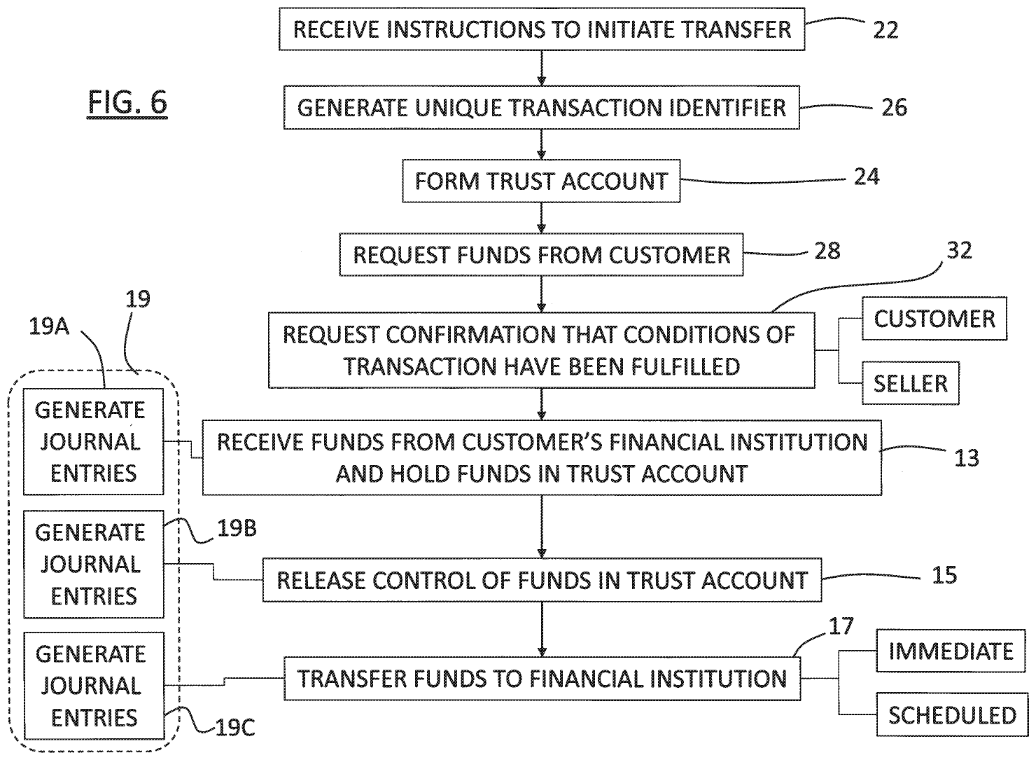

FIG. 6 shows another arrangement of the method in which the step of requesting confirmation that transaction conditions have been fulfilled, indicated at 32, takes place before step 13, that is before funds have left the customer's bank account at their financial institution. In such an arrangement, if the transaction conditions are not fulfilled, then step of requesting confirmation as to fulfillment thereof may be repeated until the conditions are fulfilled; in other words, step 13 and following steps are not performed until all transaction conditions are satisfied. Alternatively, the transaction may be cancelled so as not to progress through the steps following step 32 in FIG. 6.

In this manner, the trusted intermediary is not in a position where it may have to return funds to the customer if the transaction cannot proceed because all conditions thereof have not been satisfied.

Furthermore, if the system is configured to provide the refund automatically to the customer, in which case the customer's financial account information is provided to the trusted intermediary in parallel with the transfer of funds at step 13, then in the arrangement represented by FIG. 6, the trusted intermediary does not receive such customer financial information. This may be beneficial for privacy of the customer.

In the arrangement represented by FIG. 6, there may be a single trust ledger account stored in the trusted intermediary's database, such as the trust ledger account payable to the seller, and ENT₂ as shown in FIG. 3 is not generated, since funds will not be returned to the customer after leaving their financial account.

In yet another variation of the previously described arrangements, the method performed by the trusted intermediary may be configured to transfer funds between a common customer and a plurality of different sellers engaged in transactions for respective prescribed amounts on a common (transaction) date. Generally speaking, each transaction may be represented by a distinct invoice. This may be particularly relevant when the different sellers are presented to the customer in a common marketplace, such as a virtual or online marketplace. In such a variation of the method, which is more similar to the arrangement of FIG. 6 than FIG. 2 in that the funds are received from the customer's financial institution after the conditions of the transactions have been fulfilled, electronically receiving funds from the customer's financial institution at step 13 comprises receiving, from the customer's financial institution, funds in an amount of a sum of the transactions between the customer and the different sellers. For disbursal to each of the different sellers, the received lump sum of the funds may be initially held in a digital wallet of the customer in the trusted intermediary's system and subsequently transferred to distinct trust accounts each associated with one of the sellers. Thus, when the customer's financial institution levies banking fees on a per-transaction basis, this variation of the method may act to reduce banking fees incurred by the customer.

It will be appreciated that the trusted intermediary acts as an “Accounting Services Provider” which is a participant in a service that provides accounting information to accounting system of one or more parties, such as sellers and buyers, in a format suitable for posting to a ledger and can include payment from the buyer to the seller.

Moreover, according to the present invention, accounting entries are generated for both parties involved in the transaction basically at the same time, and basically concurrently with the actual transfer of funds associated with the transaction, based on a common data set. Since the transfer of funds is performed in real-time, and concurrently with the accounting entries representing same, there are no timing differences that may necessitate reconciliation of accounts, greatly reducing the work of accounts receivable or account payable departments of the respective parties to confirming such matters as receipt of goods and services, prices, etc.

The following is an example of a transaction involving the method described hereinbefore. Commercial transactions can, by electronic means, be recorded and paid simultaneously by both parties, the buyer and the seller.

In this example it is assumed that each step takes place at computer speed. In actual fact, some will take less. Even regulated purchases such as pharmaceuticals may be dealt with almost instantly.

The electronic devices involved are common electronic devices such as mobile cellular communications devices and personal computers. There is also a trusted intermediary that guides the movement of funds by a standing agreement between the parties, that is the customer and the seller, and enforced by the trustee. Here are the steps:
1. A customer finds a desired product(s) at acceptable price(s) on the internet or in a store and places an order by adding it to its shopping cart.
2. Seller accepts the purchase request and agrees to fill the request.
3. Customer supplies the required funds (see Note 1 below)
4. Seller gets acknowledgement that the funds are held in trust by the trusted intermediary until goods are delivered.
5. Accounting entries are generated for both the customer and seller which will complete the accounting requirements for the transactions.
6. Funds are released to the seller by the trusted intermediary once goods are released.
7. Upon confirmation of delivery of the customer's order the customer will release the funds held in trust to the seller. The funds may be sent to the seller's bank account immediately or allowed to remain in trust until the end of the processing day when all funds due to the seller that have not otherwise been distributed will be distributed to the sellers.

Note: The funds may be supplied at the beginning of the process or later when the terms of the agreement have been fulfilled. The advantage of the latter option is that once the sale has been consummated the provision for refunds is not required.

The scope of the claims should not be limited by the preferred embodiments set forth in the examples but should be given the broadest interpretation consistent with the specification as a whole.

1. A method for use by a trusted intermediary to electronically transfer funds associated with a transaction between a first party and a second party, wherein one or more of the first party and the second party have financial accounts with financial institutions each having an established relationship with the trusted intermediary such that funds transferred between a respective one of the financial instructions and the trusted intermediary are cleared in real-time, the method comprising:
(i) electronically receiving, from a first one of the financial institutions associated with the first party, funds usable for the transaction, and holding said funds in a financial account of the trusted intermediary and in trust of the first party, wherein said financial account of the trusted intermediary defines a trust account;
(ii) releasing, to the second party, control of the funds held in the trust account subject to confirmation that conditions of the transaction have been fulfilled;
(iii) electronically transferring the funds released to the second party to a financial account associated with the second party; and
(iv) generating respective accounting entries for the first party and the second party for posting the transaction to respective ledgers associated with the first party and the second party.

2. The method of claim 1 wherein generating respective accounting entries comprises generating distinct accounting entries for two or more of steps (i) to (iii).

3. The method of claim 2 wherein the distinct accounting entries are generated at each of steps (i) to (iii).

4. The method of claim 1 further including transmitting the respective accounting entries to the first party and to the second party for subsequent recordation in the respective ledgers.

5. The method of claim 1 further including storing the respective accounting entries in a database of the trusted intermediary.

6. The method of claim 5 wherein the respective accounting entries are stored in the database of the trusted intermediary in the respective ledgers associated with the first party and the second party.

7. The method of claim 1 further including:
generating a unique identifier associated with a transfer of the funds, which is associated with the transaction; and
associating the unique identifier with each of steps (i) to (iii).

8. The method of claim 1 further including:
before receiving funds usable for the transaction from the first financial institution of the first party, receiving instructions to initiate a transfer of the funds to the second party; and
forming the trust account, which is distinct, for use in the transfer, wherein the trust account is initially configured to be payable to the first party.

9. The method of claim 8 wherein releasing control of the funds held in the trust account comprises reconfiguring the distinct trust account to be payable to the second party.

10. The method of claim 1 further including, before releasing control of the funds in the trust account, requesting the confirmation that conditions of the transaction have been fulfilled, comprising:
requesting, from the second party, confirmation that obligations associated with the second party, have been fulfilled; and
requesting, from the first party, confirmation that the obligations associated with the first party have been fulfilled.

11. The method of claim 10 wherein requesting confirmation that conditions of the transaction have been fulfilled is performed before step (i).

12. The method of claim 1 wherein transferring the funds released to the second party is performed at a scheduled future time on a date of the transaction.

13. The method of claim 1 wherein, when the second party comprises a plurality of different second parties respectively engaged in a transaction for a prescribed amount of funds with the first party and on a common transaction date, electronically receiving funds usable for the transaction from the first financial institution of the first party comprises electronically receiving funds in an amount of a sum of the transactions between the first party and the different second parties.

14. The method of claim 1 wherein the financial account associated with the second party is a selected bank account at a second one of the financial institutions associated with the second party.

15. A method for use by a trusted intermediary to electronically transfer funds associated with a transaction between a first party and a second party, wherein the first party and the second party have accounts with financial institutions each having an established relationship with the trusted intermediary such that funds transferred between a respective one of the financial instructions and the trusted intermediary are cleared in real-time, the method comprising:
(i) electronically receiving, from a financial institution associated with the first party, funds usable for the transaction, and holding the funds in a financial account of the trusted intermediary and in trust of the first party;
(ii) releasing control of the funds held in the financial account of the trusted intermediary to a selected one of the first party and the second party based on input requested from at least one of the first party and the second party that conditions of the transaction have been fulfilled, wherein the second party is selected if the input determines all of the conditions have been fulfilled and the customer is selected otherwise;
(iii) electronically transferring the funds released to the selected one of the first party and the second party to a selected account associated with the selected one of the first party and the second party; and
(iv) generating respective accounting entries for the first party and the second party for posting the transaction to respective ledgers associated with the first party and the second party.

16. A computer-implemented method for use by a trusted intermediary to facilitate a transaction between a buyer and a seller and involving a transfer of funds therebetween, wherein the transaction is associated with a purchase to be made by the buyer from the seller and having a price, wherein the buyer and the seller have financial accounts with financial institutions each having an established relationship with the trusted intermediary such that funds transferred between a respective one of the financial instructions and the trusted intermediary are cleared in real-time, the method comprising:
receiving, from the buyer, information about the purchase to be made from the seller;
substantially at the same time as receiving information about the purchase to be made from the seller, electronically receiving, from a first one of the financial institutions associated with the buyer, funds usable for the price of the purchase, and holding said funds in a financial account of the trusted intermediary and in trust of the buyer;
releasing, to the seller, control of the funds held in said financial account subject to confirmation that conditions of the transaction have been fulfilled; and
electronically transferring the funds released to the seller to a financial account associated with the seller.

17. The computer-implemented method of claim 16 further including forming the financial account of the trusted intermediary for holding the funds from the buyer, which is distinct and associated with the buyer.

18. The computer-implemented method of claim 17 wherein, when the distinct financial account of the trusted intermediary is initially configured to be payable to the buyer, releasing control of the funds held in said financial account comprises reconfiguring the distinct financial account of the trusted intermediary to be payable to the seller.

19. The computer-implemented method of claim 16 wherein the financial account of the trusted intermediary is a trust account.

20. The computer-implemented method of claim 16 further including, before releasing control of the funds in the financial account, requesting the confirmation that conditions of the transaction have been fulfilled, comprising:
requesting, from the seller, confirmation that conditions associated with the seller, have been fulfilled; and
requesting, from the buyer, confirmation that conditions associated with the buyer have been fulfilled.

21. The computer-implemented of claim 16 wherein, when there is a step of requesting the confirmation that conditions of the transaction have been fulfilled prior to releasing control of the funds in the financial account, the method further includes returning control of the funds to the buyer if it is determined that the conditions of the transaction have not been fulfilled.

22. The computer-implemented method of claim 16 wherein the funds received from the first financial institution associated with the buyer are received from a bank account at the first financial institution.

23. The computer-implemented method of claim 16 further including generating respective accounting entries for the buyer and the seller for posting the transaction to respective ledgers associated with the buyer and the seller.

24. The computer-implemented method of claim 16 wherein the financial account associated with the seller is a selected bank account at a second one of the financial institutions associated with the seller.
